(19) United States
(12) Patent Application Publication
(10) Pub. No.: US 2005/0256725 A1
(43) Pub. Date: Nov. 17, 2005

(54) Funeral anniversary reminder

(76) Inventor: Jennifer Hope Harris, Cleveland, OH (US)

Correspondence Address: PAUL V. KELLER, LLC, 4585 LIBERTY RD., SOUTH EUCLID, OH, 44121, US

(21) Appl. No.: 10/690,908

(22) Filed: Oct. 22, 2003

(51) Int. Cl. G06F 17/60

(52) U.S. Cl. 705/1

(57) ABSTRACT

The invention relates to a funeral/memorial/death anniversary reminder service. This service helps funeral attendees to reflect on the life of the deceased and, where appropriate, to contact the bereaved and express support on a funeral anniversary. Contrary to common wisdom, under certain circumstances, expressing support to the bereaved on the funeral anniversary has a positive effect and is appreciated. The service can be an effective way of advertising a funeral related business.

### TECHNICAL FIELD OF THE INVENTION

The present invention relates generally to the funeral industry, and in particular a service to the bereaved that has the effect of advertising a funeral business.

### BACKGROUND OF THE INVENTION

Funeral directors face a challenge in that it is difficult for them to advertise while maintaining a sense of decorum. There is a stigma attached to being a funeral director that arises from the nature of the work. There is a tendency to view funeral directors as profiting from death and grief. This view can be exacerbated when funeral directors advertise. As a result, funeral directors hesitate to advertise and the vast majority of consumers select a funeral home by referral or from previous knowledge and experience.

Nevertheless, funeral directors are in business: they face competition and the risk of loss. The present invention serves a long under-satisfied need for methods by which funeral directors can seek to enlarge their business without acting in an unseemly manner.

Conventional wisdom is that the bereaved need to “move forward” and forget about deceased loved ones. People are generally hesitant to do anything that might remind the bereaved of their loss. Nonetheless, some organizations recognize the need of the bereaved for support long after the funeral, particularly around funeral anniversaries. In Judaism, a one-year funeral anniversary, called Yahrzeit (Jahrzeit), is observed. Organizations such as MADD and hospices send relatives of the deceased notes on funeral anniversaries.

The literature recognizes the potential value of friends and community in supporting the bereaved and the potential isolation of the bereaved after the funeral. While the above-mentioned institutions and organizations communicate directly with the bereaved, they are not known to facilitate contact between friends of the bereaved (or members of the greater community) and the bereaved on funeral anniversaries.

### SUMMARY OF THE INVENTION

The following presents a simplified summary of the invention in order to provide a basic understanding of some of its aspects. This summary is not an extensive overview of the invention and is intended neither to identify key or critical elements of the invention nor to delineate its scope. The primary purpose of this summary is to present some concepts of the invention in a simplified form as a prelude to the more detailed description that is presented later.

One aspect of the invention relates to a service that comprises (a) providing a funeral or memorial service and (b) providing attendees of the service with the opportunity to elect to receive a funeral anniversary reminder. This service helps funeral and memorial service attendees to reflect on the life of the deceased, and where appropriate, to contact the bereaved and express support on the funeral anniversary. Contrary to common wisdom, under many circumstances expressing support to the bereaved on the funeral anniversary has a positive effect and is appreciated.

Another aspect of the invention relates to a method of advertising a funeral business comprising obtaining a list of funeral or memorial service attendees and, shortly before the funeral anniversary, providing the attendees with a reminder that the funeral anniversary is approaching. The reminder includes the name of a funeral business and can suggest contacting the bereaved given certain circumstances. The reminder draws favorable attention to the funeral business.

A further aspect of the invention relates to a display comprising a funeral register and instructions regarding how a person filling out the register can elect to receive a funeral anniversary reminder. Preferably, the election can be recorded on the register, which is convenient vehicle for the person making the election.

Other aspects of the invention relate to computer-readable media useful in generating funeral anniversary reminders. In one embodiment, a computer-readable medium contains a database of persons to receive a funeral anniversary reminder and funeral event data. In another embodiment, the computer-readable medium contains software instructions for maintaining a database and generating funeral anniversary reminders.

A further aspect of the invention related to a service comprising (a) fulfilling requests to send flowers and (b) providing persons requesting that flowers be sent in connection with a death the opportunity to elect to receive a funeral anniversary reminder

Advantages and novel features of the invention will become apparent from the following detailed description of the invention and the accompanying drawings. The detailed description of the invention and the drawings provide exemplary embodiments of the invention.

### BRIEF DESCRIPTION OF THE DRAWINGS

FIG. 1 is a reproduction of a poster that can be displayed in conjunction with a funeral register to provide funeral attendees the opportunity to elect to receive a funeral anniversary reminder in accordance with one aspect of the invention.

FIG. 2 is an exemplary note that can be sent as part of a reminder in accordance with another aspect of the invention.

FIG. 3 illustrates the layout for a brochure that can be distributed in funeral homes or mailed as part of a reminder according to the invention.

FIG. 4 is a reproduction of panel A of the brochure illustrated in FIG. 3.

FIG. 5 is a reproduction of panel B of the brochure illustrated in FIG. 3.

FIG. 6 is a reproduction of panel C of the brochure illustrated in FIG. 3.

FIG. 7 is a reproduction of panel D of the brochure illustrated in FIG. 3.

FIG. 8 is a reproduction of panel E of the brochure illustrated in FIG. 3.

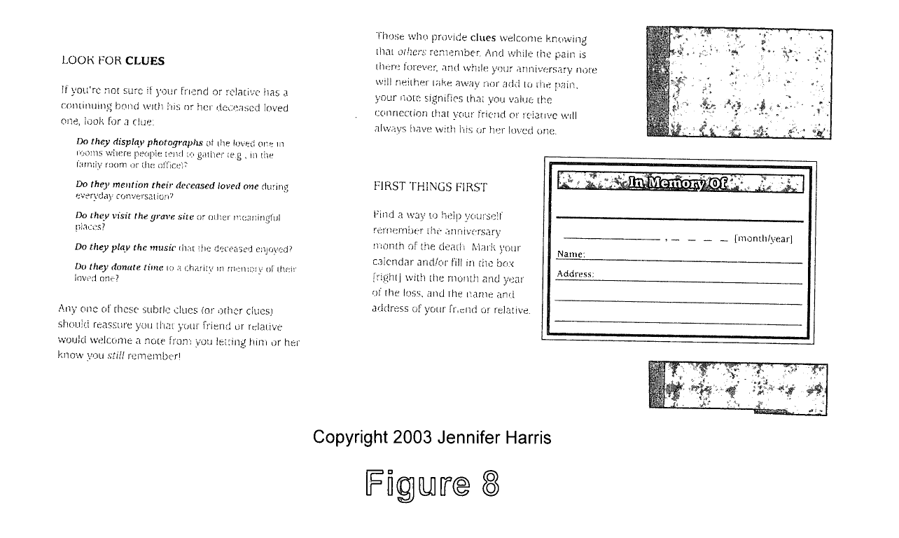

FIG. 9 is a reproduction of panel F of the brochure illustrated in FIG. 3.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In this application, a funeral anniversary is an anniversary of a funeral event. A funeral event is either a funeral service, a memorial service, a burial, a cremation, or a death. The funeral anniversary can be any anniversary, including for example, a 90 day anniversary, a six month anniversary, a one year anniversary, a two year anniversary, a five year anniversary, or a ten year anniversary. The anniversary date can be calculated based on the Gregorian/Western/New Style calendar, the Julian/Old Style calendar, the Hijri/Islamic calendar, or the Hebrew/Jewish calendar.

The present invention relates to a method of advertising a funeral business and at the same time providing a service to the bereaved and their supporters. The method comprises (a) obtaining a list of funeral attendees, preferably attendees requesting the service, and (b) providing them with a reminder of a funeral anniversary shortly before the anniversary date. The funeral anniversary is preferably the one year Gregorian calendar anniversary of a funeral service. The reminder can be a cue to contact bereaved persons such as spouses, parents, children, and friends of the deceased.

Long after the funeral, many bereaved persons maintain bonds with their deceased loved ones. Contrary to long held views, for the well adjusted bereaved, “holding on” to a continuing bond is not only normal, but healthy. These individuals continue to experience a sense of loss combined with endless memories of the deceased loved one. Under many circumstances, they welcome the acknowledgment of these bonds and are likely to be grateful for a heartfelt note around the funeral anniversary.

A funeral anniversary reminder is a communication that reminds the recipient that an anniversary of a funeral event is approaching. Preferably, the reminder includes the exact date of the funeral event or the exact date of the anniversary. Having an exact date can give the recipient confidence in contacting the bereaved. The reminder can, but is not required to, suggest contacting the bereaved. Contact can be, for example, by post, telephone, e-mail, or in person. The reminder can also be made by any of these methods.

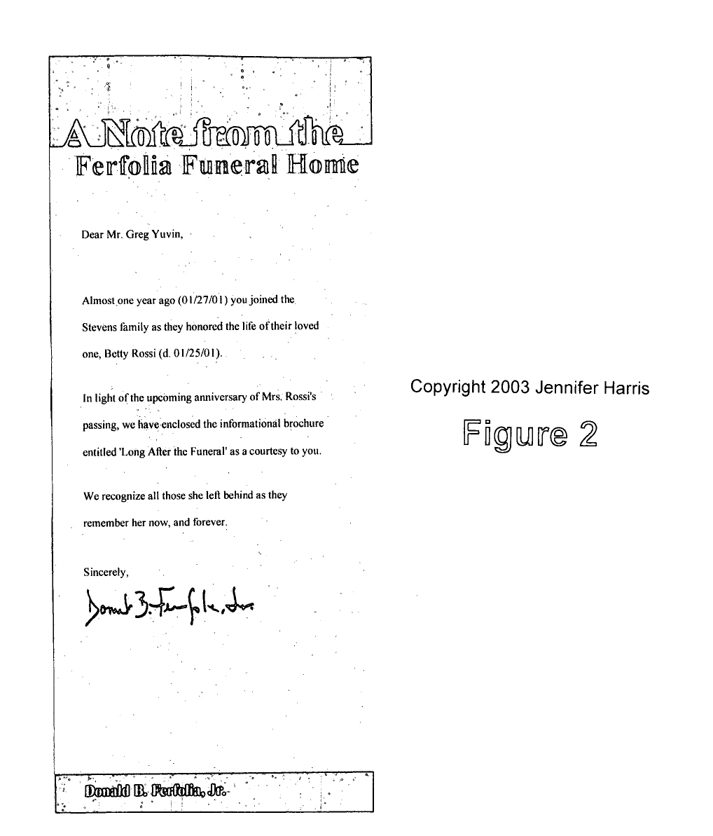

FIG. 2 is a reproduction of an exemplary note that is part of a reminder sent in a mass mailing to funeral attendees. The exemplary note includes the date of the funeral event, the full name of the bereaved, and a brief sentiment. The note also includes the name of a funeral home and a funeral director, which not only identifies the origin of the note to the recipient, but also allows the note to function as an advertisement. The note is sufficient to function by itself as a reminder, but in this exemplary embodiment the reminder also includes a brochure having various elements that add value to the reminder.

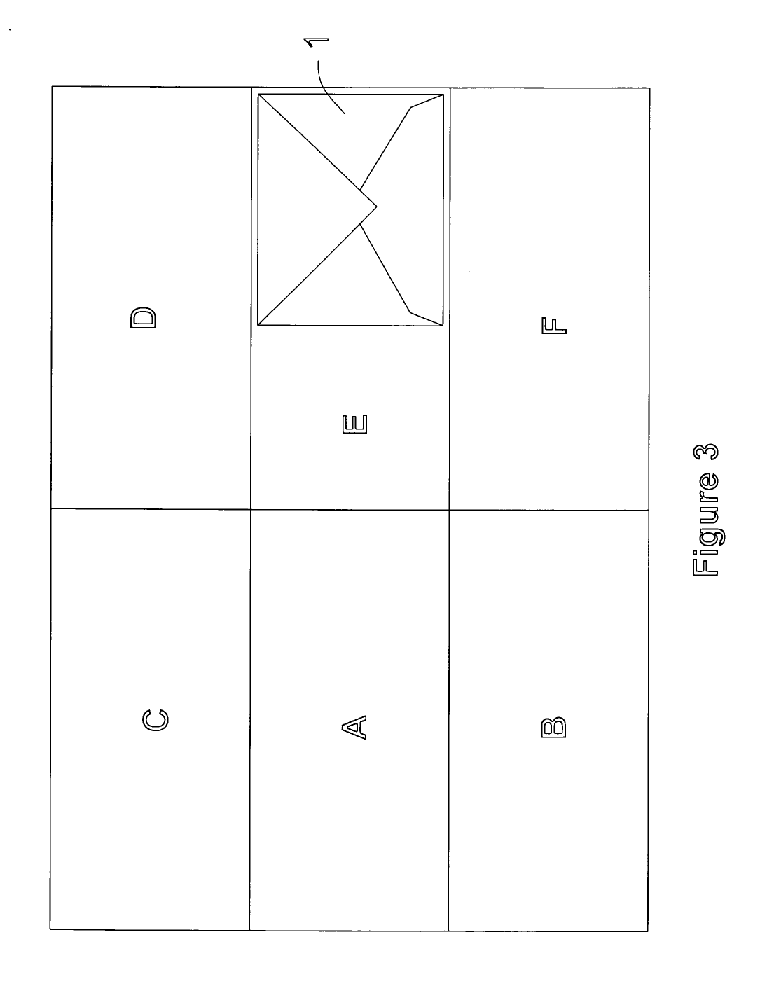

The layout for an exemplary brochure is illustrated in FIG. 3. The brochure is printed on 8.5 by 11 inch paper and folded in thirds to create six panels, A-F. Panels A-C are on one side and Panels D-F are on the other. The brochure is folded so that panels A and B remain visible. An envelope 1 with a piece of stationery inside is attached to panel E to facilitate sending a supportive note. The exemplary brochure can be left on display in a funeral home, although in this example it is mailed as part of a reminder.

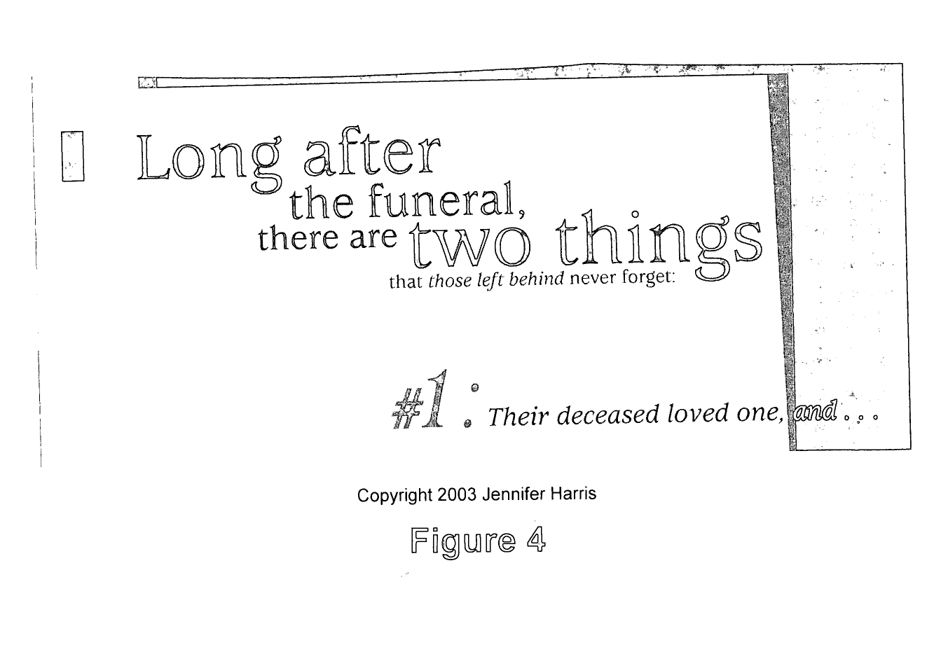

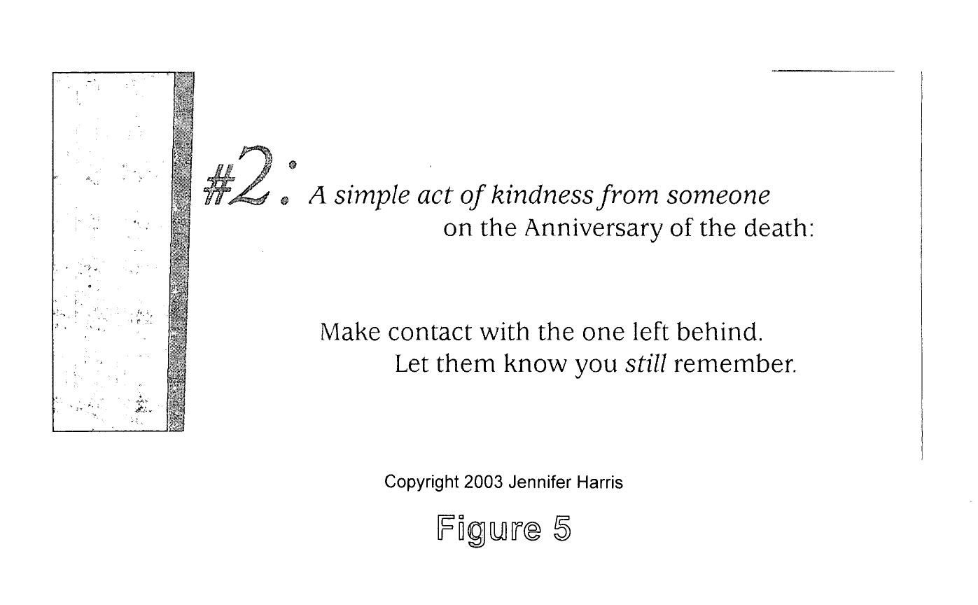

Panels A and B, reproduced in FIGS. 4 and 5 respectively, give the gist of the idea of contacting the bereaved. The writing is large and limited to allow reading at a glance. The panels simply suggest that, under certain circumstances, making contact with the bereaved on a funeral anniversary is a nice thing to do.

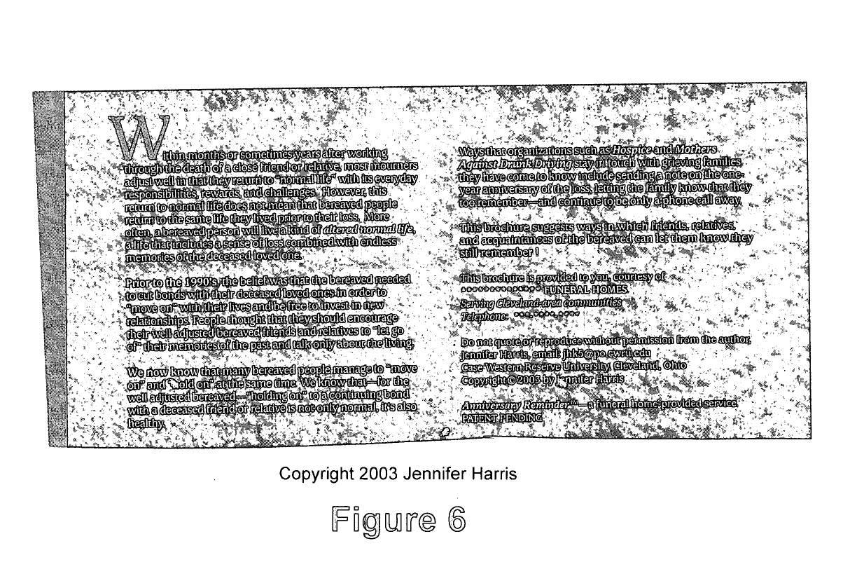

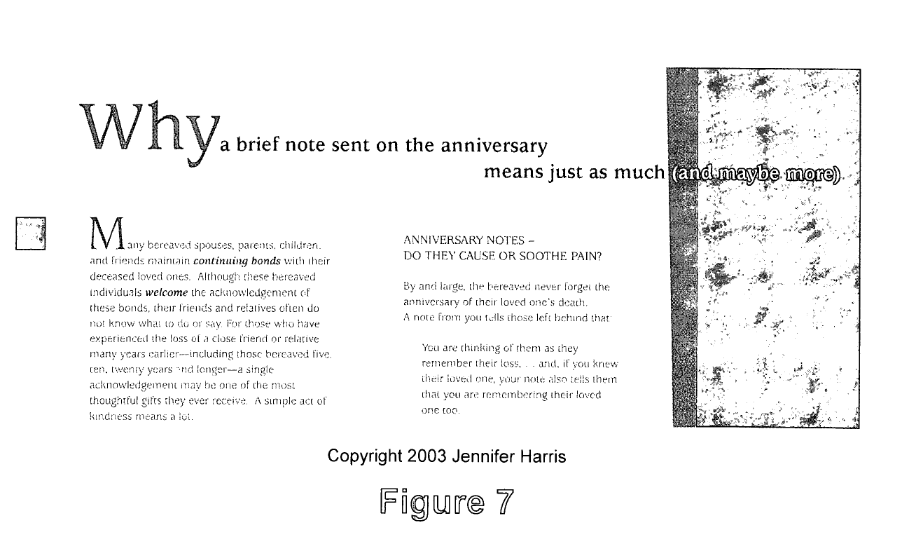

Panels C and D, reproduced in FIGS. 6 and 7 respectively, go into greater detail. They explain the potential need of the bereaved for support long after the funeral and specifically address the common concern that a note to the bereaved might cause rather than soothe pain. Panel D also includes a location for a funeral home name as part of the advertising function.

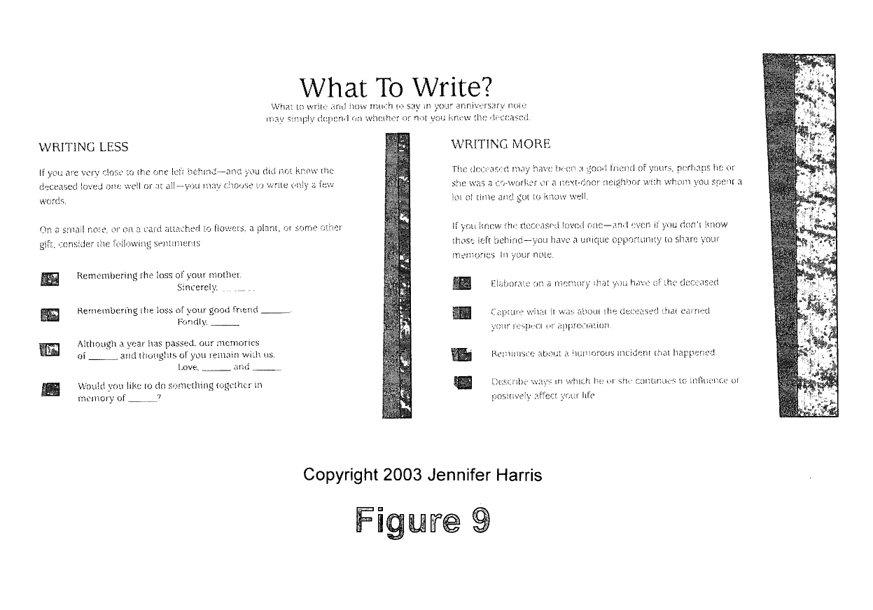

The desirability of contacting the bereaved on a funeral anniversary varies according to circumstances and it is preferred that a reminder provide guidelines regarding whether a contact would be beneficial. Guidelines on whether or not to make contact with the bereaved can be based on whether the bereaved maintains a continuing bond with the deceased. The guidelines can suggest looking for signs of a continuing bond. Signs of a continuing bond can include, for example, displaying photographs of the deceased, mentioning the deceased during everyday conversation, making donations in memory of the deceased, and visiting the grave site. The guidelines can suggest making contact if one or more of these signs or clues are Panel F of the exemplary brochure, reproduced in FIG. 9, provides this guidance.

A funeral anniversary reminder becomes a method of advertising when it includes the name of a funeral business. The name could be the name of a funeral director, a funeral home, or a chain of funeral homes. Under certain circumstances, a note on a funeral anniversary is likely to be appreciated by the bereaved person. In turn, the bereaved person is subsequently likely to express appreciation to the sender. When this appreciative acknowledgment is received, it creates a positive experience for the sender and reflects favorably on the funeral business that suggested sending the note in the first place. Reminding attendees of the funeral business name in connection with a positive experience some time after the funeral can create a strong memory that leads to new business, particularly where the funeral itself leaves a good impression.

The list of attendees can include all or only a portion of those who attended the funeral. In a preferred embodiment, the list includes only those attendees who elect to receive a funeral anniversary reminder. An attendee list can be obtained from a funeral register. For purposes of the present disclosure, the term funeral register encompasses a register provided in connection with a memorial service. A funeral register is typically written, although audio and electronic registers are also possible. The register preferably includes places to enter the attendee's name and contact information. Contact information preferably includes at least an address. Preferably, the attendees are able to elect the anniversary reminder service by marking the funeral register.

There are a variety of means by which an attendee can elect to receive an anniversary reminder. In one example, a display, such as a poster or pamphlet, which can be next the register, explains the anniversary reminder service and how to elect to receive it. The election can be made, for example, by placing a check mark next to or otherwise highlighting the attendee's name on the register, placing an “X” or other mark in a box provided to indicate the election on the register, entering the attendee's name in a separate list for those electing the service, filling out a card, pushing a button, calling a number, replying to an e-mail message, or making a request through a web site. The election can also be made orally, where a person asks the attendee whether they would like the service and records positive responses. Preferably, the service is offered and the election is made at the funeral, although it is also possible to explain the service and/or offer the election at a later date, by mail or e-mail for example.

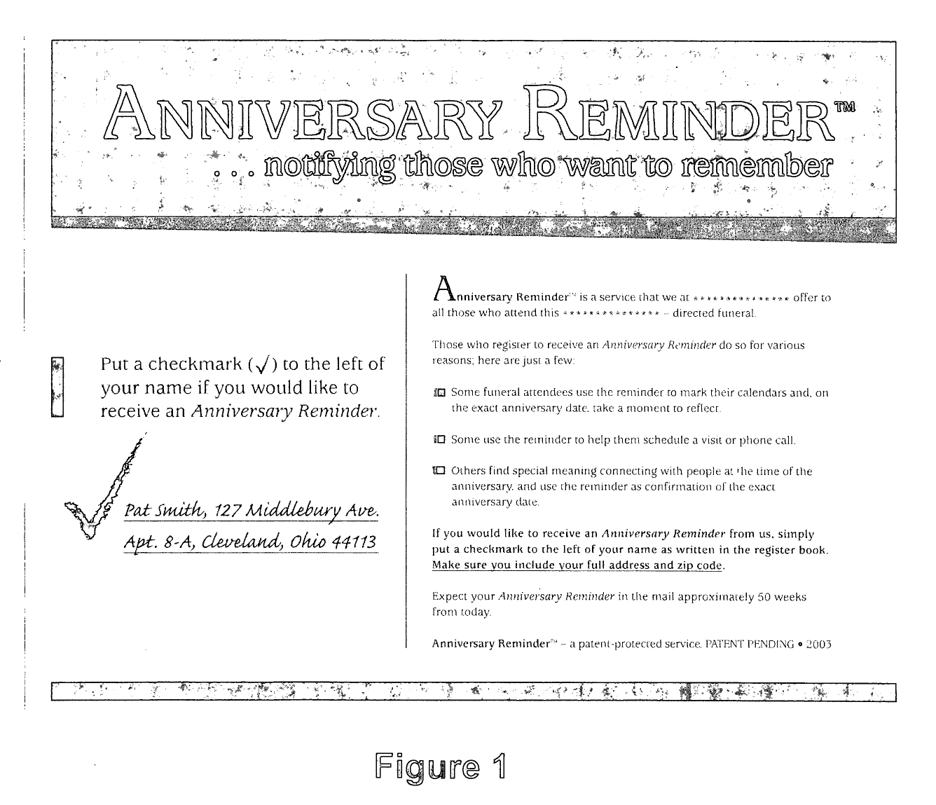

FIG. 1 is a reproduction of an exemplary poster that can be displayed next to a funeral register and, in conjunction with the register, provides a means for funeral attendees to elect to receive a funeral anniversary reminder. This poster briefly describes potential benefits of the service. It may be desirable to include a brochure nearby to provide information for those who wish to learn more about funeral anniversaries and the service.

Shortly before the anniversary date means within a month of the anniversary date. Preferably the notice is receive “just-in-time” meaning far enough in advance to plan and send an appropriate note or gift, but not substantially further in advance. Preferably, the reminder is received one to three weeks before the anniversary, most preferably about a week and a half before.

Another aspect of the invention relates to software to be used in sending out funeral anniversary reminders. The software includes a database of persons who are to receive funeral anniversary reminders and data regarding funeral events. Funeral event data includes, for example, the funeral event or anniversary date and the name of the deceased. The software provides the user, such as a funeral home or florist, with guidance in sending out anniversary reminders. The software can provide information regarding when reminders are to be sent. This information can be, for example, in the form of a “to-do” list or a calendar. Optionally, the software automatically generates the reminders without being prompted by the user. Even if the software does require prompting by the user, it is preferable that the software be capable of generating reminder notes for mailing, the reminder notes including at least the name of the deceased and either the funeral event date or the anniversary date. More preferably, the reminders are personalized with recipient information as is the note reproduced in FIG. 2. Preferably, the software can be installed on a personal computer. The software instructions can be created, for example, with a standard database program such as Microsoft Access®.

A further aspect of the invention relates to florists. Florists, like funeral directors, are in the position of coming into contact with persons who desire to support the bereaved. Florists can offer funeral anniversary reminders to people who purchase flowers or plants from their establishments in connection with funeral events. A reminder from a florist can include the florists name and/or a suggestion to send flowers or plants to people

Although the invention has been shown and described with respect to certain embodiments, alterations and modifications providing equivalent structures and acts are likely to occur to those of ordinary skill in the art upon the reading and understanding this specification and the associated drawings. Such alterations and modifications are intended to fall within the scope of the present invention, unless expressly stated to the contrary. Components described in functional terms have structure and involve acts, unless otherwise indicated, corresponding to any of the devices and methods known to those of ordinary skill in the art to perform those functions, even though not equivalent to any of the structures and acts that perform those function in the exemplary embodiments of the invention. In addition, while a particular feature of the invention may have been disclosed with respect to only one of several embodiments, such feature may be combined with one or more other features of the other embodiments as may be desired or advantageous for a given or particular application.

1. A service, comprising:
providing a funeral or memorial service; and
providing attendees of the service with the opportunity to elect to receive a funeral anniversary reminder.

2. The service of claim 1, further comprising providing the anniversary reminder.

3. The service of claim 2, wherein the reminder is a reminder to contact the bereaved.

4. The service of claim 2, wherein the reminder includes suggestions for what to write in a note to the bereaved.

5. The service of claim 2, wherein the reminder includes guidelines for whether to contact the bereaved in regard to the anniversary.

6. The service of claim 2, wherein the reminder includes either the date of the funeral or the exact date of the anniversary.

7. The service of claim 1, wherein the opportunity to elect to receive the reminder is given at the funeral service.

8. The service of claim 1, wherein the attendees elect to receive the reminder by appropriately marking a funeral register.

9. A method of advertising a funeral business, comprising:
obtaining a list of funeral or memorial service attendees; and
shortly before a funeral anniversary date, providing attendees of the service with a reminder that the funeral anniversary date is approaching;
wherein the reminder includes the name of a funeral business.

10. The method of claim 9, wherein the reminder is a reminder to contact the bereaved.

11. The method of claim 10, wherein the reminder includes suggestions for what to write in a note to the bereaved.

12. The method of claim 9, wherein the reminder includes guidelines for whether to contact the bereaved.

13. The method of claim 9, wherein the list of funeral attendees is a list of funeral attendees who elect to receive the reminder.

14. The method of claim 9, wherein the reminder includes either the date of the funeral event or the date of the anniversary.

15. The method of claim 9, wherein the reminder includes a brochure that explains potential benefits of contacting a bereaved person regarding the funeral anniversary.

16. The method of claim 15, wherein the brochure has a design that lends itself to being handed out or picked up at a funeral or memorial service.

17. A display comprising:
a funeral register; and
instructions for how a person filling out the register can elect to receive a funeral anniversary reminder.

18. The display of claim 17, wherein the election can be made on the register.

19. A computer-readable medium having stored thereon a data structure useful in generating funeral anniversary reminders, comprising:
a list of persons to receive funeral anniversary reminders; and
funeral event data.

20. The computer-readable medium of claim 19, wherein the data structure further comprises a field for indicating whether a person has elected to receive a funeral anniversary reminder.

21. A computer-readable medium having software instruction, comprising:
software instructions for maintaining a list of persons to receive a funeral anniversary reminder; and
software instructions for generating funeral anniversary reminders for delivery to persons on the list.

22. The computer-readable medium of claim 21, further comprising software instructions for informing a user as to when the reminders are to be sent.

23. The computer-readable medium of claim 21, wherein the funeral anniversary reminders for delivery are generated upon request by a user.

24. A service, comprising:
fulfilling requests to send flowers or plants; and
providing persons requesting that flowers or plants be sent in connection with a funeral event the opportunity to elect to receive a funeral anniversary reminder.

25. The service of claim 24, further comprising providing the anniversary reminder.

26. The service of claim 24, wherein the reminder includes a suggestion to send flowers or plants.
